(19) United States
(12) Patent Application Publication
(10) Pub. No.: US 2014/0359475 A1
(43) Pub. Date: Dec. 4, 2014

(54) Dynamic Panel of Inlined Control Settings

(71) Applicant: Microsoft Corporation, Redmond, WA (US)

(72) Inventors: Krishna Venkatesh, Seattle, WA (US); Andrew Olcott, Seattle, WA (US); Ramrajprabu Balasubramanian, Renton, WA (US); Mark Yalovsky, Seattle, WA (US); Kenton A. Shipley, Woodinville, WA (US); Nishad Mulye, Sammamish, WA (US); Peter Seraphim Ponomarev, Seattle, WA (US); Jon Gabriel Clapper, Seattle, WA (US)

(73) Assignee: Microsoft Corporation, Redmond, WA (US)

(21) Appl. No.: 14/033,270

(22) Filed: Sep. 20, 2013

Related U.S. Application Data
(60) Provisional application No. 61/828,550, filed on May 29, 2013.

(51) Int. Cl. G06F 3/0484

(52) U.S. Cl. CPC G06F 3/0484
USPC 715/747

(57) ABSTRACT

The techniques and systems described herein present various examples of a settings analytics component which provides for different ways to create a customized control settings panel for a user to modify system or application control settings. For example, in an environment where a user of a computing device with an operating system allows user configuration of system control settings, the settings analytics component may track and store user behaviors in regard to the modification of system control settings. The settings analytics component may then base the creation of a customized control settings panel on the tracked and stored user behaviors in regard to the modification of system control settings.

### PRIORITY CLAIM AND CROSS-REFERENCE TO RELATED APPLICATION

This application claims the benefit of, and priority to, U.S. Provisional Patent Application No. 61/828,550, filed May 29, 2013, which is incorporated by reference herein in its entirety.

### BACKGROUND

Most user operating systems and applications allow users to personalize their operating environment or applications by allowing access to various system or control settings. In the case of an operating system, such control settings may include monitor brightness, mouse sensitivity, sound preferences, among many other types of control settings. In the case of an application, such control settings may include different types of commands or application preferences. However, traditionally, in order for a user to make a change to any given control setting, the user must navigate through a control settings hierarchy including a number of links and/or icons each time a change is to be made.

### SUMMARY

The techniques and systems described herein present various implementations of a settings analytics component which provides for different ways to create a customized control settings panel for a user to directly modify system or application settings. For example, in an environment where a user of a computing device with an operating system allows user configuration of system settings, the settings analytics component may track and store user behaviors in regard to the modification of system settings. The settings analytics component may then base the creation of a customized control settings panel on the tracked and stored user behaviors in regard to the modification of system settings. In some cases, many different types of criteria are used in selecting control settings, ranking the control settings, and determining a layout in creating a customized control settings panel.

In some implementations, the techniques and systems described herein may be used to provide a dynamic list of a user's frequently used, recently used, or recommended settings, where the list can be modified in accordance with control settings that the user has interacted with. The dynamic list may be generated by a weighting of control settings according to frequently used, recently used, and a general importance to the user. The general importance may be determined by assigning a value to each control setting based on one or more factors (e.g., user preference, frequency of access, recency of access), and the value is used to indicate an overall importance of the setting to the user. In some cases, the customized control settings panel can aggregate particular control settings for one or more applications and/or one or more systems that are otherwise accessible via a number of different paths.

Further, the techniques and systems described herein may be used to record each time a user changes a control setting. The control setting may be changed from a navigation path including a series of user interfaces accessible via respective links and/or icons, but the control setting may also be added to a customized control settings panel and changed directly from the customized control settings panel, as well. When a user accesses the customized control settings panel, the control settings included in the customized control settings panel may be determined by a number of factors, such as recently used and frequently used. The control settings included in the customized control settings panel may include a list of top scoring/most relevant control settings associated with the user. The control settings included in the customized control settings panel may have the same or substantially the same appearance as the appearance of the respective control settings when accessed via the navigation path for the control settings.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a first example computing environment including an implementation of a settings analytics component according to some implementations.

FIG. 2 illustrates a second example computing environment including an implementation of a settings analytics component according to some implementations.

FIG. 3 illustrates a flow diagram depicting a first method to generate a customized control settings panel according to some implementations.

FIG. 4 illustrates a flow diagram depicting a second method to generate a customized control settings panel according to some implementations.

FIG. 5 illustrates a flow diagram depicting a method to determine content of a customized control settings panel according to some implementations.

FIG. 6 illustrates a customized control settings panel according to some implementations.

FIG. 7 illustrates a computer system for implementing a settings analytics component in accordance with the implementations described herein.

### DETAILED DESCRIPTION

The techniques and systems described herein are directed to various implementations of a settings analytics component that provides for different ways to create a customized control settings panel, such that a user may utilize to modify system or application control settings directly from the customized control settings panel. A customized control settings panel may be invoked in a variety of different ways, including system menus, a desktop shortcut, as an application on a mobile device, or within a panel displayed upon a user logging in to a system.

For example, in an environment where a user of a computing device with an operating system allows user configuration of system control settings, the settings analytics component may track and store user behaviors in regard to the modification of system control settings. In some cases, the settings analytics component may detect and store each change to each system control setting, including characteristics and/or parameters of the change being made. Further, the settings analytics component may detect and store frequency of use and time of use associated with each control settings change.

Given collected analytics data in regard to tracking usage of control settings, the settings analytics component may base the creation of a customized control settings panel at least partly on the collected analytics data for user behaviors in regard to the modification of system control settings. In some cases, many different types of criteria are used in creating a customized control settings panel, including criteria beyond the collected analytics data. For example, analytics data from other users may be used to provide suggested control settings within a customized control settings panel, or to provide an initial set of control settings in the case a user has very little or no analytics data history.

In some implementations, in creating a customized control settings panel, the settings analytics component may, in addition to using the collected settings analytics, partly base a determination of which control settings to include in the customized control settings panel on a tree ordering of the control settings. A tree ordering may be considered to be a predetermined hierarchical organization of control settings of an operating system or application, such that an order of control settings is consistent. For example, in a tree ordering of control settings, if a control setting for modifying mouse characteristics is ordered before a control setting for modifying monitor characteristics, then in an ordering of control settings, the mouse control setting occurs before the monitor setting. In particular, in some examples, if the modifying monitor characteristics control setting and the mouse control setting are ranked such that they are both determined to be included in a customized control settings panel, then regardless of one or more elements of user analytics specifying a different ordering, the layout of the customized control settings panel including the modifying monitor characteristics control setting and the mouse control setting may remain consistent with the ordering specified by the tree ordering. In this way, in some implementations, without any direct or manual input from a user, control settings to include in a customized control settings panel may be determined.

In some implementations, the settings analytics component may, in addition to using the collected settings analytics, partly base a determination of which control settings to include in the customized control settings panel on pinned settings. A pinned control setting may be any given control setting that has been previously displayed within a customized settings panel such that the given control setting has been directly selected or “pinned” by a user to be displayed in a consistent location within the customized control settings panel.

For example, given an initial display of four control settings within a customized control settings panel, where a first control setting is displayed in the top left corner of the control settings panel, a second control setting is displayed in the top right corner of the control settings panel, a third control setting is displayed in the bottom left corner of the control settings panel, and a fourth control setting is displayed in the bottom right corner of the control settings panel, if a user pins or indicates that the second control setting is to be displayed consistently, then the settings analytics component may display the second control setting in the top right corner of the control settings panel even if other analytics factors, such as disuse or more frequent use, indicate that the second setting may have a different location in the control settings panel.

In some implementations, the settings analytics component may allow a user to directly manipulate system control settings or application properties through a customized control settings panel as if the user had directly modified the control setting within the navigational structure in which the control setting exists within the system. In other words, a modification to a control setting within a customized control settings panel created with the settings analytics component may produce the same or equivalent effect as if the user had modified the control setting as provided from the operating system outside of the settings analytics component. For example, a user may access a control setting via the customized control settings panel without having to select a series of links or icons to navigate through a hierarchical structure of user interfaces associated with different control settings and/or different levels of control settings. In this way, the settings analytics component does not merely provide a link to an original system setting, but rather, the settings analytics component allows for inlined modifications to a control setting. In some implementations, this direct modification of system or application control settings from within the customized control settings panel occurs through communication from the customized control settings panel using a call or calls to an application programming interface(s) with the operating system.

Similarly, in some implementations, the settings analytics component may allow a user to directly manipulate user application settings or properties through a customized control settings panel as if the user had directly modified the control setting within the navigational structure in which the control setting exists within the user application. In other words, a modification to a control setting within a customized control settings panel created with the settings analytics component may produce the same or equivalent effect as if the user had modified the control setting as provided from the user application outside of the settings analytics component. In this way, the settings analytics component does not merely provide a link to an original user application control setting, but rather, the settings analytics component allows for inlined modifications to control settings.

In some implementations, the settings analytics component may combine control settings from different user applications into a single customized control settings panel. In other implementations, the settings analytics component may combine settings from the operating system with settings from a single user application or multiple user applications.

In some implementations, the settings analytics component may determine particular control settings and in which position the particular control settings may be located within a customized control settings panel based on a combination of different factors. For example, the settings analytics component may use importance criteria based on analytics data in regard to control settings usage to determine a ranking of control settings, use a tree-ordering of settings to determine a relative placement of settings within a customized control settings panel, and utilize user configuration information, such as a user selecting particular control settings to be included in the customized control settings panel. Further, the settings analytics component may use a pre-defined, or user-defined quantity to determine how many control settings to display in a customized control settings panel. In some examples, the settings analytics component may determine a quantity of control settings to use even without any user input specifying a quantity. In other examples, the importance criteria may be based at least partly on recency of use and/or frequency of use of a control setting and/or suggested control settings. In using these various factors, the settings analytics component may create a customized control settings panel of inlined control settings without any direct or specific user configurations or manual selection of control settings to include in a customized control settings panel.

### Example Implementations

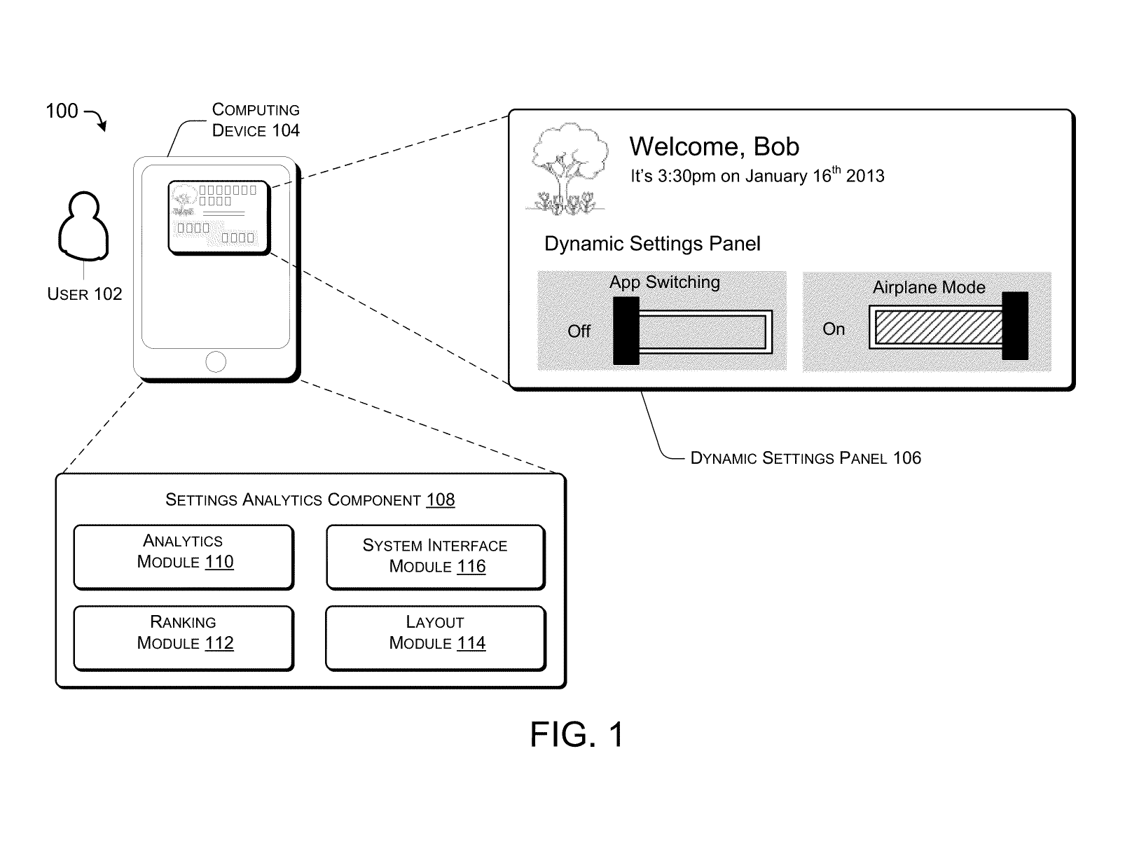

FIG. 1 illustrates an overview of an environment 100 in which a settings analytics component may operate. In this example environment 100, a user 102 may interact with a computing device 104, where some of the user interactions may include selecting and setting various system or application control settings. In this example, dynamic settings panel 106 is an example of a customized control settings panel created by a settings analytics component, such as a settings analytics component 108. The dynamic settings panel 106 may also be referred to herein as a customized control settings panel.

In some implementations, the computing device 104 may, through hardware or software or a combination of both, be configured to implement the settings analytics component 108. In some cases, the settings analytics component 108 may include an analytics module, such as analytics module 110, for tracking and collecting system or application usage data. The settings analytics component 108 may also include a ranking module, such as ranking module 112, for determining one or more control settings to include within the dynamic settings panel 106. The settings analytics component 108 may also include a layout module, such as layout module 114, for determining, based on various criteria, a layout of the determined one or more control settings to include in the dynamic settings panel 106. Further, the settings analytics component 108 may include a system interface module, such as system interface module 116, for communicating with various system and/or application processes or storage. In some cases, the system interface module 116 may communicate with system or application processes or storage through one or more application programming interfaces.

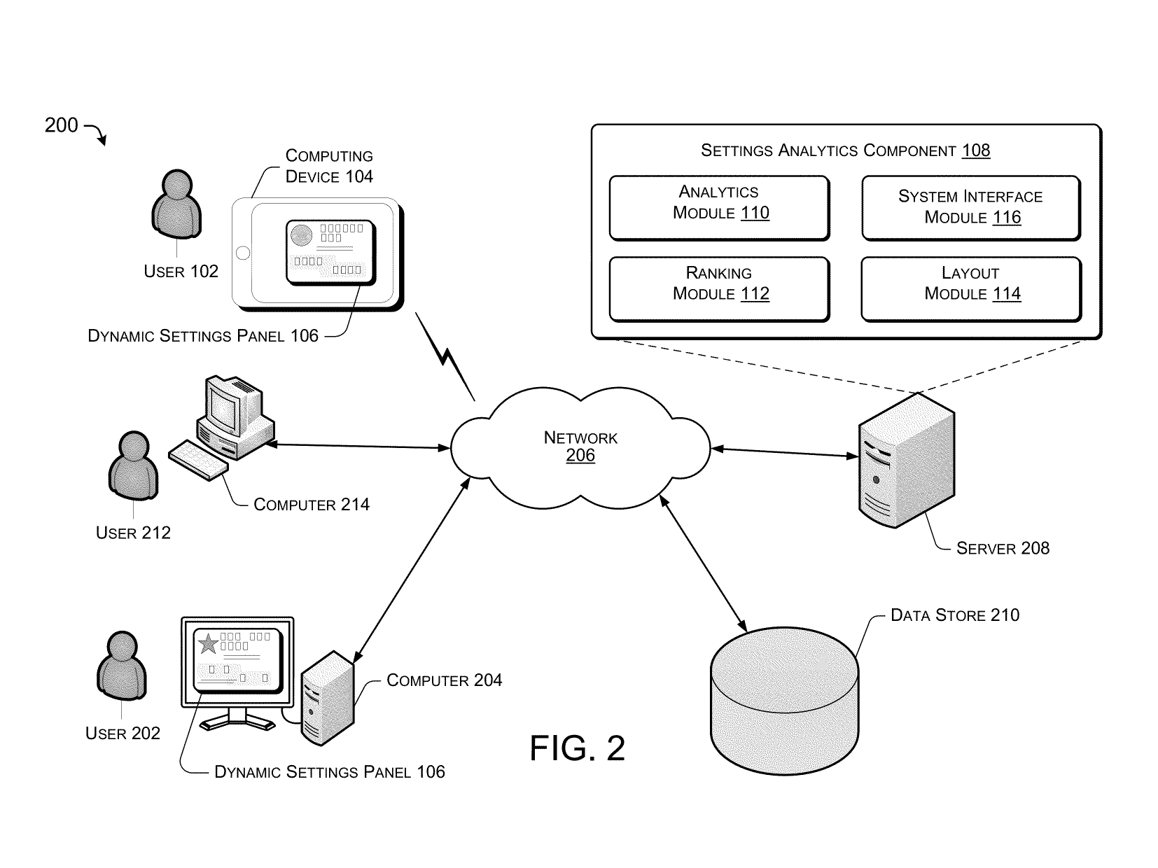

FIG. 2 illustrates an overview of a computing environment 200, which depicts an additional computing environment in which a settings analytics component may be implemented. In this example environment, a user 202 may interact with computer 204, where some of the user interactions may include selecting and setting various system or application control settings, and where the selection and setting of these control settings may be detected and collected locally and transmitted over network 206 to the settings analytics component 108 executing remotely on server 208. In some examples, the server 208 may store the analytics data locally, and in other cases, the server 208 may store the analytics data remotely within a data store, such as data store 210. In such an environment, the analytics data may be used by the server 208, in addition to other servers, for storing collective analytics data, or crowd sourced analytics data, from multiple different users. For example, the settings analytics component 108 on the server 208 may collect and analyze measured user behavior in regard to system or application control settings for many different users, such as users 212 and 102, using computer 214 and the computing device 104, respectively.

In this way, an implementation of the settings analytics component 108 may serve to use settings analytics data collected from multiple different users, across multiple different devices, in order to use this settings analytics data in ranking control settings and determining which control settings to include within a customized control settings panel for a single user.

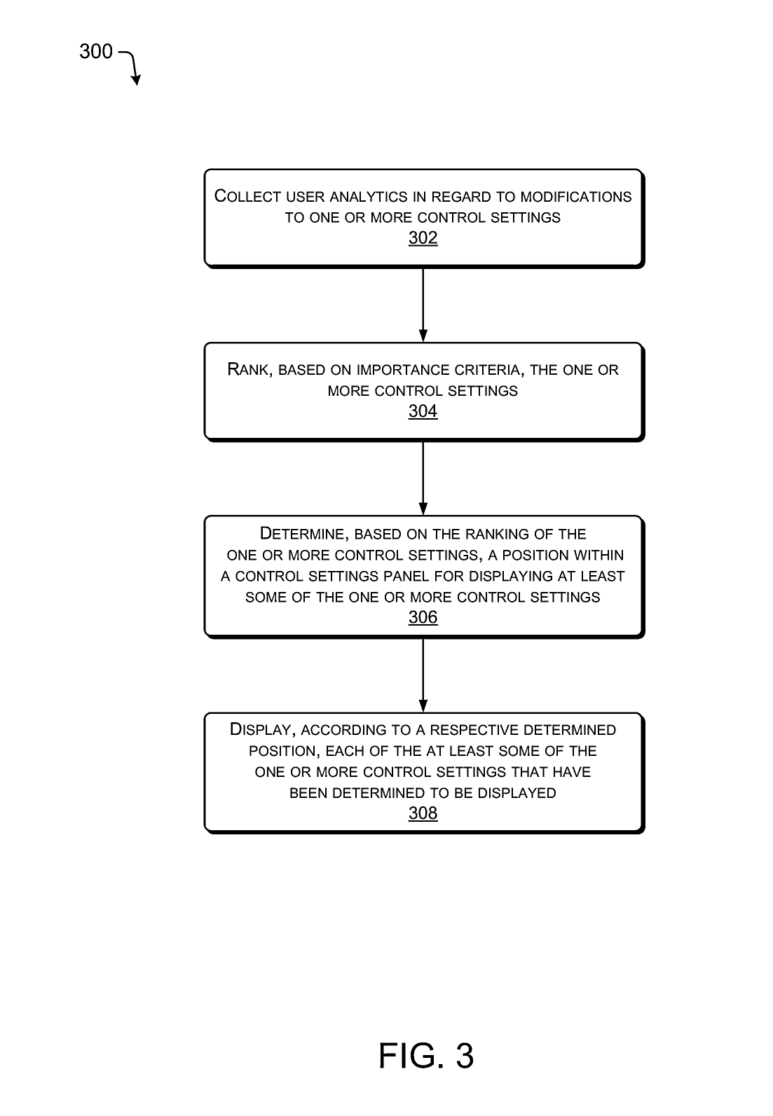

FIG. 3 depicts a method 300, including some of the features within an implementation of a settings analytics component, as it may operate within computing environments 100 and 200. Some of the features include operations that can be implemented in hardware, software, or a combination thereof. In the context of software, the features represent computer-executable instructions stored on one or more computer-readable media that, when executed by one or more processors, perform the recited operations.

In this example, the settings analytics component may monitor and detect some or all user modifications to system or application control settings, as depicted at 302. For example, each time a control panel is opened, and a control panel user interface element is modified or is operated to obtain more information, the settings analytics component may detect and store any changes or operations performed. In this way, not only modifications are stored, but also user operations for obtaining more information. For example, if a user frequently opens a system panel that provides information on workloads or network loads or cache settings, then the settings analytics component may include such information within a tile or user interface region of a customized control settings panel, even if no modifications are made by the user.

In some implementations, the settings analytics data may be stored locally or remotely, and the settings analytics data may be detected and collected based on other settings that have been changed through operations besides the control panel user interfaces. For example, a user may execute a batch file that specifies definitions for various system control settings, and this may be detected and tracked. In other words, any system or application control settings change, regardless of the manner in which the change is performed, may be detected and stored for later analysis by the settings analytics component.

Further, in this example, given stored settings analytics data, the settings analytics component may rank a list of control settings according to importance criteria, as depicted at 304. For example, the settings analytics component may base a ranking of prospective control settings to include in a customized control settings panel, at least partly on most recently used settings and/or most frequently used settings, as determined according to the collected settings analytics data.

In some implementations, the settings analytics component may also base a ranking on additional importance criteria, such as suggested settings, which may be determined based on user profile information for the specific user, or which may be determined based on user profile information gathered from multiple users, or a combination thereof. In other implementations, the suggested control settings may be based on a similarity of a control setting that the user has not used with a control setting that the user has used. For example, if a user has modified a particular security-related control setting, the settings analytics component may determine that another security-related control setting that the user has not used may be relevant, and the other security-related control setting may be a suggested control setting. In some implementations, the settings analytics component may augment a list of control settings collected from actual user use with control settings from a suggested control settings list.

In this example, given a determination of a ranking of control settings, the settings analytics component may then determine how many control settings to display within a customized control settings panel. The number of control settings to display may be a fixed number defined prior to user use, or the number of control settings to display may be a configurable number based on a user specification, or the number of control settings to display may be based at least partly on a display size and/or size of the customized control settings panel. In some cases, a user may specify through a menu option of a customized control settings panel, how many control settings the user may wish to include within the customized control settings panel.

In this example, after the settings analytics component has determined a number of control settings to display, and a ranking of those control settings has been determined, the settings analytics component may determine a relative position within a customized control settings panel for displaying the determined number of control settings, as depicted at 306. As discussed below, other factors may be used in determining which control settings are selected for inclusion within a customized control settings panel, such as suggested control settings, information indicating user specified control settings to include, and different ways of balancing relative criteria in determining which control settings are selected.

In this example, the determined number of control settings may then be displayed within the customized control settings panel in positions based on relative importance of the determined number of control settings to display, as depicted at 308. In other examples, the positions or layout of the determined control settings to include in the customized control settings panel may be further based on information specified by a user regarding the location of control settings in a customized control settings panel and/or a tree ordering and/or other criteria.

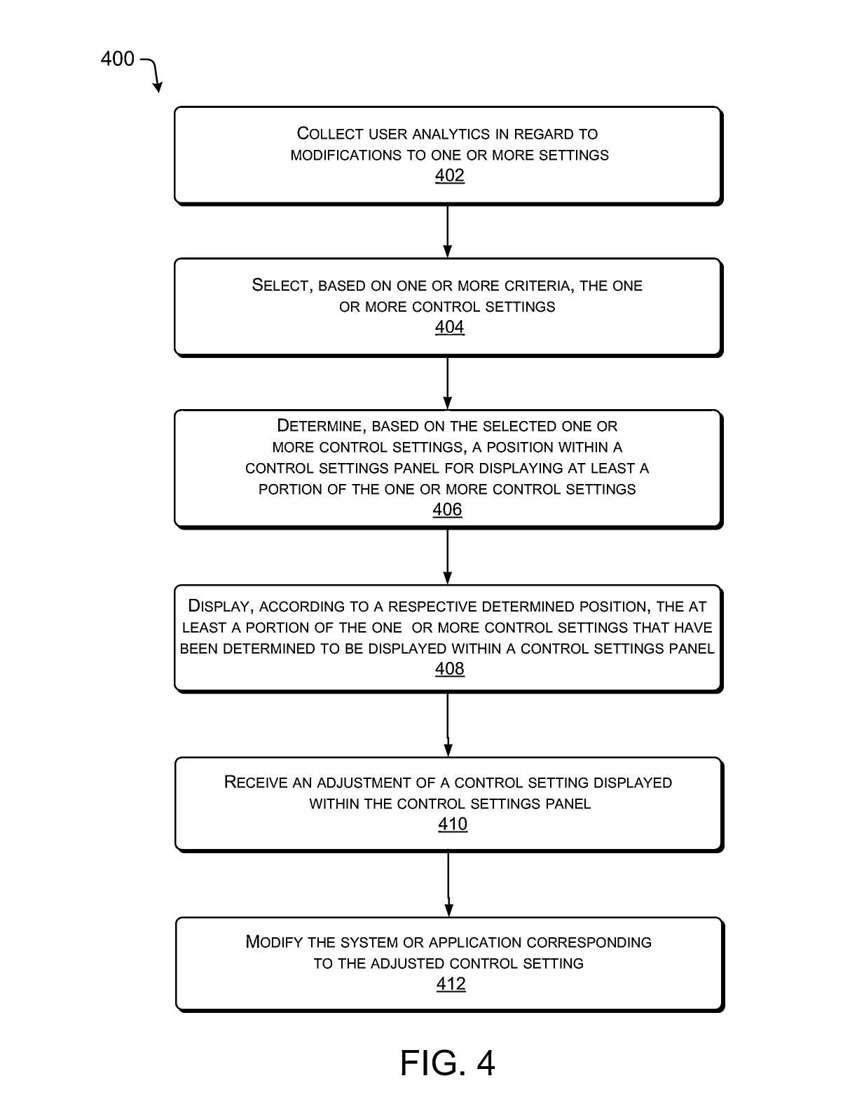

FIG. 4 depicts a method 400, including some of the features within an implementation of a settings analytics component similar to the settings analytics component described with respect to FIG. 3, but with discussion of additional aspects of features related to generating a customized control settings panel. In this example, the settings analytics component may monitor and detect any user modifications to a system or application control settings, as depicted at 402.

In this example, based partly on stored control settings analytics data, the settings analytics component may select a list of control settings according to importance criteria, as depicted at 404. For example, the settings analytics component may base a selection of control settings on most recently used control settings and/or most frequently used control settings, as determined according to the collected settings analytics data. In other examples, the settings analytics component may determine importance criteria based at least partly on the types of applications a user has used or installed. For example, if a user installs security or anti-malware software, then the settings analytics component may determine that control settings related to computer or network security may be added or suggested within a customized control settings panel. In this example, control settings related to security may be controls for changing the security level in a default browser, or all browsers, in addition to a control setting for firewall settings for the operating system.

In some implementations, the settings analytics component may also base a ranking on additional importance criteria, such as suggested control settings, which may be determined based on user profile information for the specific user, or which may be determined based on user profile information gathered from multiple users, or a combination thereof. In some implementations, the settings analytics component may augment a list of control settings collected from actual user use with control settings from a suggested control settings list. In other implementations, the settings analytics component may augment a list of control settings collected from a single user with settings determined from settings analytics of multiple, different additional users.

In this example, given a determination of a ranking of control settings, the settings analytics component may determine how many control settings to display within a customized control settings panel. The number of control settings to display may be a fixed number defined prior to user use, or the number of control settings to display may be a configurable number based on a user specification. For example, a user may specify through a menu option of a customized control settings panel, how many control settings the user may wish to include within the customized control settings panel.

Further, in this example, after the settings analytics component has determined a number of control settings to display, and particular control settings to include in a customized control settings panel, the settings analytics component may determine a relative position or layout within the customized control settings panel for displaying the selected control settings, as depicted at 406.

In this example, the selected control settings may then be displayed within a generated customized control settings panel, such that the control settings are displayed in positions based at least partly on relative importance of the determined number of control settings to display, as depicted at 408. As noted above, in some examples, the settings analytics component may use other criteria in determining a final layout or positioning of control settings determined to be included within a customized control settings panel. In a particular implementation, the selected control settings may be displayed within the customized control settings panel as a list having a particular order based, at least in part, on the importance calculated for each selected control setting.

In this example, after generating and displaying a customized control settings panel to a user, the settings analytics component may receive user input adjusting a user interface element included in the customized control settings panel that is directed at a control setting within the customized control settings panel, as depicted at 410. For example, a user may turn on or off a particular control setting, such as “Airplane Mode” in a mobile device, or some other control setting. In this example, in response to the user input adjusting a setting or value of a control setting within the customized control settings panel, the settings analytics component may modify the behavior of the corresponding system or application as if the user had directly modified the corresponding control setting to the system or application, as depicted at 412. For example, the settings analytics component may generate, in response to the received input modifying a control setting, a command to perform a corresponding adjustment, and send the command through an application programming interface to the operating system or to an application that provides the corresponding control setting. In this way, the modification of the control setting within a customized control settings panel is consistent with modification of the control setting by accessing the control setting through a series of selections within a hierarchical structure of user interfaces and/or icons because the change to the control setting within the customized control settings panel is accomplished through implementation of the operating system or application providing the corresponding control setting. In other words, the underlying software settings of the system or application are invoked through the customized control settings panel of the settings analytics component as if the user of the control setting were invoking the control setting directly through the operating system or application.

Further, in this example, when a user accesses a control settings user interface of the operating system or application directly, and not through the customized control settings panel of the settings analytics component, the setting values displayed in the customized control settings panel may be made consistent with any control settings values adjustments made by the user directly through the operating system or application. For example, if a user changes a network control setting directly through a network control application by selecting a series of icons or links to access the network control setting, the change to the network control setting will also be reflected in the customized control settings panel. Additionally, if a user modifies a control setting via a customized control settings panel, the value of the control setting will be consistent upon access of the control setting directly via an application or operating systems using selections of a series of links or icons in a hierarchical structure of control settings. In a particular implementation, the consistency between the value of a control setting when accessed either directly or via a customized control settings panel is maintained because changes to the value of the control setting are accomplished through the operating system or the application associated with the control setting regardless of how the control setting is accessed.

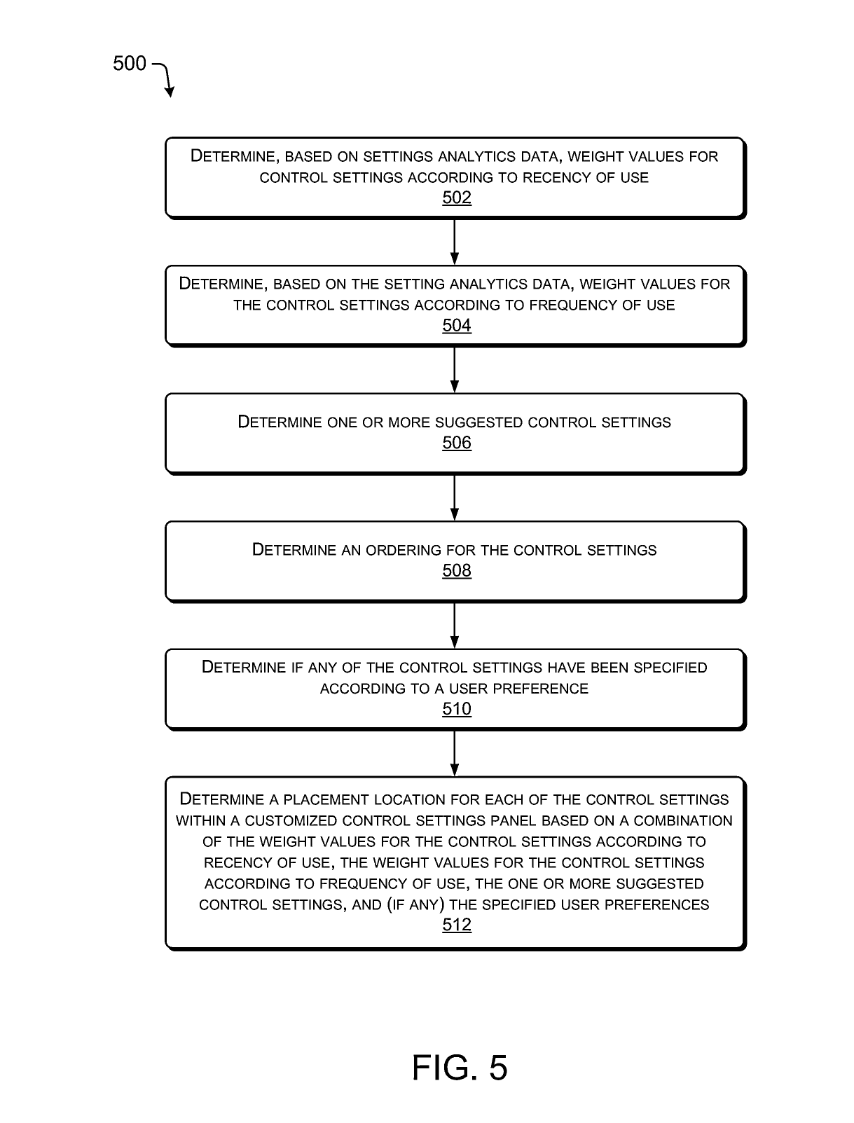

FIG. 5 depicts a method 500, including aspects of the settings analytics component related to considerations of various factors in determining a quantity and placement location of control settings within a customized control settings panel, such as may occur at 304 and 306 of FIG. 3.

In this example, as an overview, at 502-506, the settings analytics component determines which control settings and how many control settings to include within a customized control settings panel. At 508, the settings analytics component determines an ordering of the control settings such that the same control settings to be included in subsequent invocations of the customized control settings panel are displayed in consistent locations. At 510, the settings analytics component determines if any user preferences have been set in regard to the control settings to be included in the customized control settings panel. At 512, the settings analytics component determines a quantity and placement location for the control settings to be included in a customized control settings panel.

In this example, a settings analytics component may assign weights to control settings in a list of control settings that have been modified, where the weights are based at least partly on recency of use, as depicted at 502. In some implementations, the settings analytics component may assign a weight corresponding to recency of use and frequency of use of a control setting, and may assign the weight to favor one type of use metric over another. For example, for a given control setting, the settings analytics component may assign a constant value weight for recency of use that is greater than a weight for frequency of use. In some examples, in the case that a control setting is changed for a first time, the weight may simply be assigned a large number to give recency of use a high importance value. In different implementations, the weights assigned based on recency of use or frequency of use may be calculated in different ways.

Similarly, in this example, a settings analytics component may assign weights to control settings in a list of control settings that have been modified, where the weights are based on frequency of use, as depicted at 504. For example, the settings analytics component may assign a weight for a given control setting that is proportional to a number of times that the control setting has been changed. In this way, in this example, if the control setting has been changed, 20 times for example, then the weight for the control setting may be calculated to be 20, or some constant value that is proportionately changed according to frequency of use. In different implementations, the weights assigned based on frequency of use may be calculated in different ways.

The settings analytics component may also determine suggested control settings, as depicted at 506. As discussed above, suggested control settings may be determined according to a user profile, among other factors. For example, if the user has purchased a new system, then the settings analytics component may determine that control settings related to configuring a system may be appropriate and be given a large weight value. For other users, the settings analytics component may use different profile information for determining different suggested control settings. In additional implementations, a weight value corresponding to a suggested control setting may be assigned according to different methods. For example, a weight that is half the value of a weight assigned for recency of use may be used, or a weight value that is equal to a weight assigned to recency of use may be used, corresponding to how important it is to include suggested control settings within the customized control settings panel. In some examples, the weight assignments may be user specified, for example, when first invoking the customized control settings panel. Further, in some examples, when a user first invokes a customized control settings panel, suggested preferences for types of control settings to use may be based at least partly on control settings panel configurations and/or preferences of other users. For example, a new user within a graphic design group may have suggested preferences based on preferences of other users in the graphic design group, such as control settings for monitor color, resolution, or brightness, among others.

In different implementations, the operations depicted at 502-506 may be performed in different orders, with no loss of functionality or efficiency. Further, in some examples, determinations, such as weight values, from operations at 502-506 may be combined to determine a ranking of control settings. In this example, after the settings analytics component has determined which control settings to include in a customized control settings panel, in addition to a ranking of these control settings, the settings analytics component may order the control settings such that consistency is maintained when control settings changes are made. For example, if a user makes a series of modifications to two control settings, in an alternating fashion, then for the settings analytics component to avoid these two control settings from toggling in the highest ranked position, the settings analytics component may use a tree-ordering to maintain a consistent relative ordering for the two control settings. In this way, in this example, for a determined set of control settings to be included in a customized control settings panel, a user may come to rely on a relative layout or positioning of the included control settings, thereby allowing the user to be more efficient.

As discussed above, the settings analytics component may also determine if any control settings have been designated or specified to be included in particular locations, according to a user preference that may have been set or specified in a previous invocation of a customized control settings panel, as depicted at 510. For example, a user may “pin” or otherwise designate that a given control setting or given control settings, be maintained in a consistent location, such as through the selection or activation of a particular icon associated with “pinning” a control setting. In some implementations, this user preference setting may override any other determined ordering or location positioning for control settings to be included in the customized control settings panel.

In this example, at this point, the settings analytics component may have sufficient information to determine the placement location of each of the control settings determined to be included within the customized control settings panel, as depicted at 510. Further, in this example, the placement location of each, or at least some, of the control settings is partly based on the previously determined ranking of the control setting, but may be overridden by the consistent ordering, and/or further overridden with the user preference information. In other words, in this implementation, the ranking of the control settings may provide an ordering of which control settings are most important to a user. Further, this consistent ordering provides a particular look and feel for the customized control settings panel, and the user preference may serve as a final override of where to place control settings in the customized control settings panel. In other words, after the settings analytics component has determined which of the control settings to include and where to include them within a customized control settings panel, the consistency of presentation of the control settings allows a user to rely on a particular arrangement of control settings in performing subsequent modifications to a control setting within the customized control settings panel. Thus, in some cases, the ranking of control settings may be reordered such that one or more ranked control settings that appeared in a previous customized control settings panel maintains the position within a current version of a customized control settings panel. In some cases, the position of the controls setting in the previous customized control setting panel may be specified by a user preference.

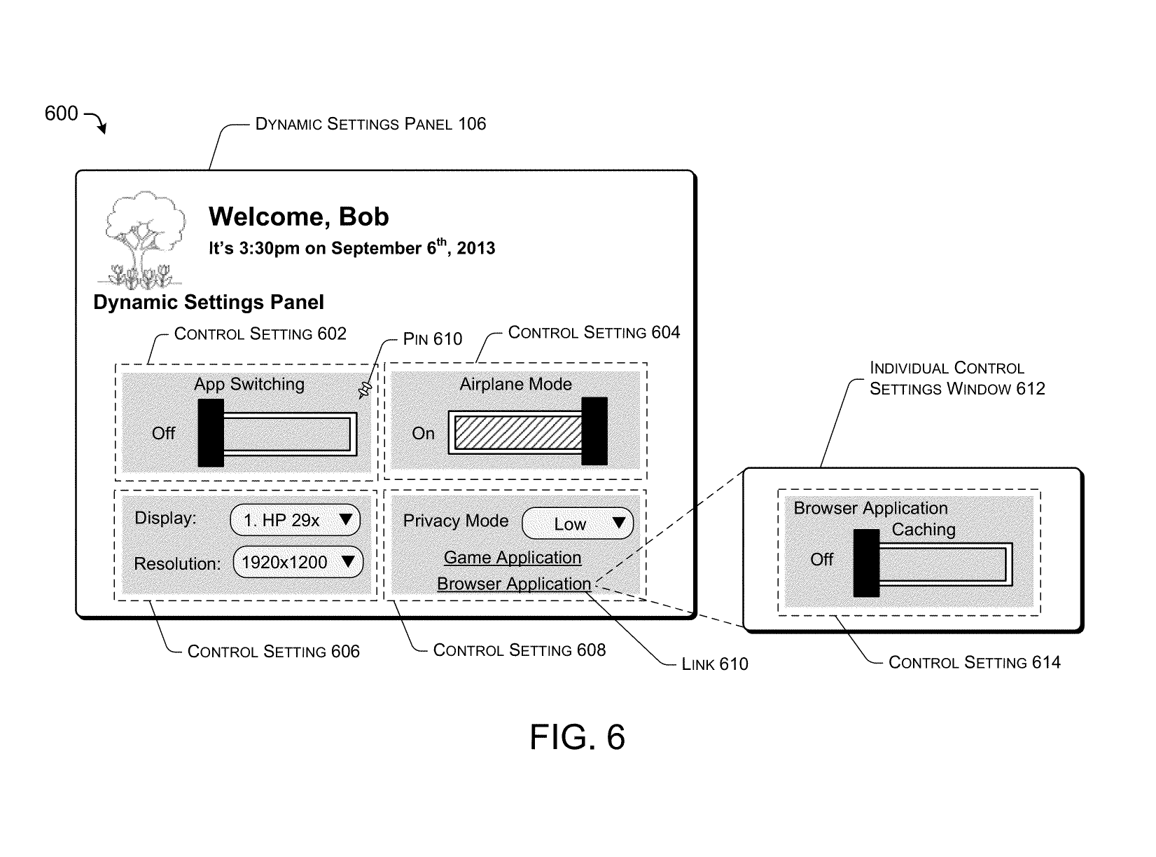

FIG. 6 illustrates a framework 600 depicting a dynamic settings panel 106 according to some implementations of a settings analytics component. In this example, the dynamic settings panel 106 may include four control settings, an application switching control setting 602, an airplane mode control setting 604, a display control setting 606, and a generic privacy control setting 608. The dynamic settings panel 106 also includes a pin 610, which is a selectable icon that allows a user to specify a preference to include the control setting 602 in the dynamic settings panel 106. The pin 610 may also be used to indicate a location of the control setting 602 in the dynamic settings panel 106.

In the illustrative example of FIG. 6, control settings 602-606 may correspond directly to control settings within the operating system or within a single application. However, in this example, control setting 608 may correspond to one or more corresponding control settings within the operating system and/or an application or applications. For example, by selecting a “Privacy Mode” as “Low,” the settings analytics component may modify one or more corresponding control settings. In this case, when a user sets the “Privacy Mode” to “Low,” the settings analytics component changes two control settings: a first control setting associated with a game application and a second control setting associated with a browser application. Further, in this example, the first control setting associated with the game application may correspond to a GPS tracking setting of “Game Application,” and may be set to “On” in response to the “Privacy Mode” being set to “Low.” Similarly, in this example, the second control setting associated with the browser application, corresponding to enabling caching for “Browser Application,” may be set to “On” in response to the “Privacy Mode” being set to “Low.” Furthermore, if a user sets “Privacy Mode” to “High,” then GPS tracking in the first control setting associated with the game application and caching in the second control setting associated with the browser application may, in response, be turned off. In another example, caching for a number of installed applications may be turned on or off with a single control setting of the customized control settings panel. In this way, a single control may be a type or category or meta-category that corresponds to multiple similar, but possibly distinct, types of control settings across multiple applications. Additionally, while a control setting within a customized control settings panel does not directly correspond to a single control setting, it may still directly modify one or more control settings within the operating system or an application.

Further, in this example, the control setting 608 may include a link for each of the applications associated with the control setting 608. In an implementation, when a user clicks on or otherwise selects a link 610 associated with the browser application, the settings analytics component may display a window of individual control settings, such as individual control settings window 612, which may include a control setting 614 for the individual application associated with the link 610. In some cases, a user may individually modify the control setting 614 included in the individual control settings window 612, rather than a global modification of the control setting 614 via the control setting 608.

### Illustrative Computing System

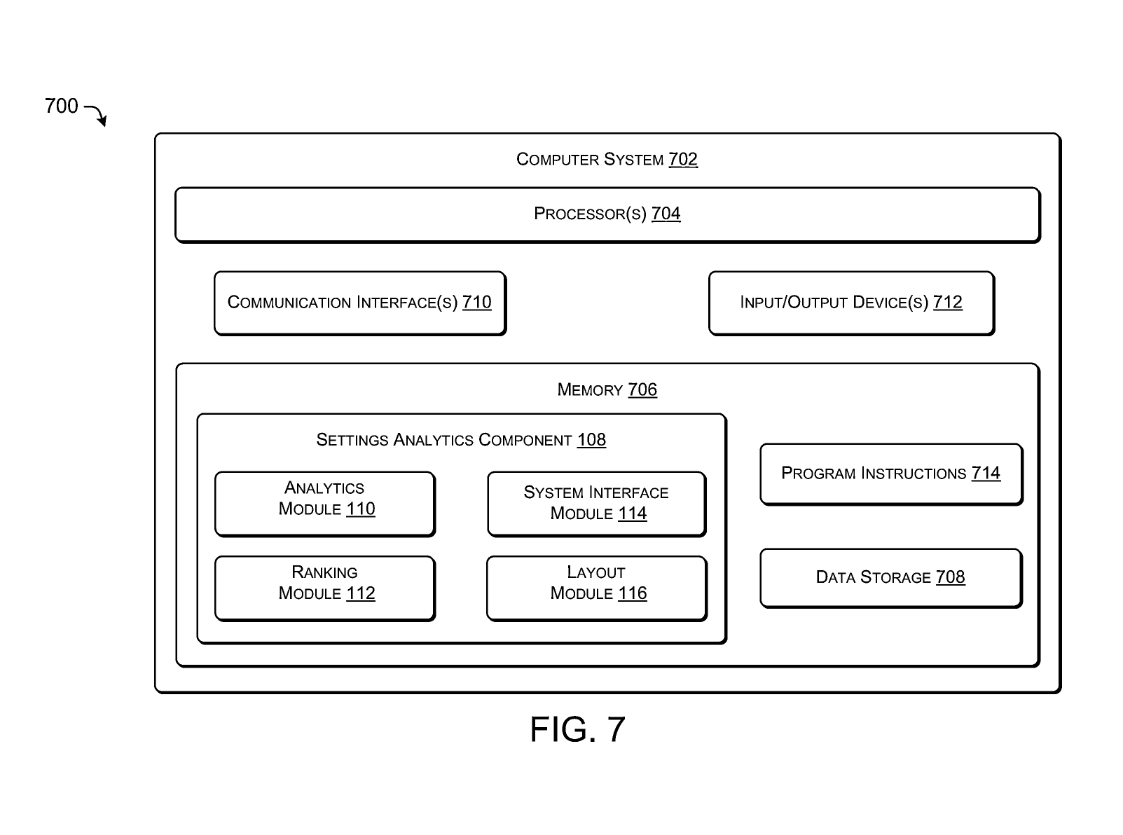

FIG. 7 further illustrates a framework 700 depicting a computer system 702. Computer system 702 may be implemented in different devices, such as the computing device 102 depicted in FIG. 1, and the computers 204, 214 of FIG. 2. Generally, computer system 702 may be implemented in any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a television, a video recording device, a peripheral device such as a switch, modem, router, or in any type of computing or electronic device.

In one implementation, computer system 702 includes one or more processors 704 coupled to memory 706. The processor(s) 704 can be a single processing unit or a number of processing units, all of which can include single or multiple computing units or multiple cores. The processor(s) 704 can be implemented as one or more microprocessors, microcomputers, microcontrollers, digital signal processors, central processing units, state machines, logic circuitries, and/or any devices that manipulate signals based on operational instructions. As one non-limiting example, the processor(s) 704 may be one or more hardware processors and/or logic circuits of any suitable type specifically programmed or configured to execute the algorithms and processes described herein. Among other capabilities, the processor(s) 704 can be configured to fetch and execute computer-readable instructions stored in the memory 706 or other computer-readable media. Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

By contrast, communication media may embody computer-readable instructions, data structures, program modules, or other data in a modulated data signal, such as a carrier wave, or other transmission mechanism. As defined herein, computer storage media does not include communication media.

The memory 706, including data storage 708, is an example of computer storage media. Further, computer system 702 may include one or more communication interfaces 710 that may facilitate communications between computing devices. In particular, the communication interfaces 710 may include one or more wired network communication interfaces, one or more wireless communication interfaces, or both, to facilitate communication via one or more networks represented by a network, such as network 206. The network 206 may be representative of any one or combination of multiple different types of wired and wireless networks, such as the Internet, cable networks, satellite networks, wide area wireless communication networks, wired local area networks, wireless local area networks, public switched telephone networks (PSTN), and the like.

Additionally, computer system 702 may include input/output devices 712. The input/output devices 712 may include a keyboard, a pointer device, (e.g. a mouse or a stylus), a touch screen, one or more image capture devices (e.g. one or more cameras), one or more microphones, a display, speakers, and so forth.

In some implementations, the invention may be implemented using a single instance of a computer system, while in other implementations, the invention may be implemented on multiple such systems, or multiple nodes making up a computer system may be configured to host different portions or instances of implementations. For example, in one implementation some elements may be implemented via one or more nodes of the computer system that are distinct from those nodes implementing other elements.

The memory 706 within the computer system 702 may include program instructions 714 configured to implement each of the implementations described herein. In one implementation, the program instructions may include software elements of implementations of the modules discussed herein, such as the settings analytics component 108, the analytics module 11, the ranking module 112, the system interface module 114, and the layout module 116. The data storage within the computer system may include data that may be used in other implementations.

Generally, computer-executable instructions include routines, programs, objects, components, data structures, and the like that perform particular functions or implement particular abstract data types. The order in which the operations are described is not intended to be construed as a limitation, and any number of the described blocks can be combined in any order or in parallel to implement the processes.

### CONCLUSION

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A system, comprising:
one or more computing nodes, each computing node comprising at least one processor and memory; and
a settings analytics component implemented by the one or more computing nodes, the settings analytics component being configured to:
detect one or more modifications to one or more control settings, each respective control setting of the one or more control settings being accessible via a particular series of user interfaces;
rank, based on one or more criteria, the one or more control settings;
determine, based at least partly on a ranking of the one or more control settings, relative positions for displaying the one or more control settings in a customized control settings panel, the customized control settings panel being distinct from the particular series of user interfaces used to access each respective control setting; and
create, based at least partly on the relative positions for the one or more control settings, a layout of control settings within the customized control settings panel.

2. The system as recited in claim 1, wherein to rank the one or more control settings, the settings analytics component is further configured to:
determine frequency data and recency data for the detected modifications to the one or more control settings;
access user analytics data for a plurality of users interacting with respective computing devices, wherein the user analytics data comprises additional frequency data and additional recency data for modifications to control settings for the plurality of users; and
combine the frequency data and recency data for the detected modifications to the one or more control settings with the additional frequency data and the additional recency data for the modifications to the control settings for the plurality of users.

3. The system as recited in claim 1, wherein the settings analytics component is further configured to:
create a call to an application programming interface for an operating system to modify a control setting within the customized control settings panel, wherein the call is equivalent to a particular call to modify the control setting generated with respect to a user interface of the particular series of user interfaces used to access the control setting.

4. A method, comprising:
performing, by one or more computing devices:
collecting user analytics describing modifications to one or more control settings;
ranking, based on one or more criteria, the one or more control settings;
determining, based on the ranking of the one or more control settings, a position within a customized control settings panel for at least a portion of the one or more control settings; and
displaying, according to a respective determined position, the at least a portion of the one or more control settings in the customized control settings panel.

5. The method as recited in claim 4, further comprising:
receiving an adjustment of a given control setting within the customized control settings panel, the given control setting corresponding to an operating system setting; and
modifying the operating system setting according to the adjustment received for the given control setting within the customized control settings panel.

6. The method as recited in claim 4, further comprising:
receiving an adjustment of a given control setting within the customized control settings panel, wherein the given control setting corresponds to a user application setting; and
modifying the user application setting according to the adjustment received for the given control setting within the customized control settings panel.

7. The method as recited in claim 4, wherein the one or more control settings include control settings from an operating system and from one or more user applications.

8. The method as recited in claim 7, further comprising:
receiving an adjustment of a given control setting within the customized control settings panel, wherein the given control setting corresponds to an operating system setting;
modifying the operating system setting according to the adjustment received for the given control setting within the customized control settings panel;
receiving an additional adjustment of an additional control setting within the customized control settings panel, wherein the additional control setting corresponds to a user application setting; and
modifying the user application setting according to the adjustment received for the additional control setting within the customized control settings panel.

9. The method as recited in claim 4, wherein the user analytics include, for a given setting of the one or more settings, frequency of use or recency of use.

10. The method as recited in claim 4, wherein the user analytics include analytics collected from a single user.

11. The method as recited in claim 10, wherein the user analytics further include analytics collected from a plurality of users.

12. The method as recited in claim 11, wherein the plurality of users comprises users of a single computing system or users of multiple computing systems.

13. The method as recited in claim 4, further comprising:
prior to the ranking, determining one or more suggested control settings to include in the customized control settings panel; and
wherein the ranking further comprises ranking the suggested control settings.

14. The method as recited in claim 4, wherein determining the position within the customized control settings panel for the at least a portion of the one or more control settings further comprises:
determining an ordering of the ranked one or more control settings, wherein the ordering may reorder a lower ranked control setting above a higher ranked control setting, and wherein the ordering is based on a tree ordering of the control settings within an operating system.

15. The method as recited in claim 14, wherein determining the position within the customized control settings panel for the at least a portion of the one or more control settings further comprises:
determining a user preference indicating that a control setting within a previous customized control settings panel remains in a particular position within a current version of the customized control settings panel; and
adjusting the ordering of the ranked one or more control settings to be consistent with the user preference indicating that the control setting within the previous customized control settings panel remains in the particular position within the current version of the customized control settings panel.

16. One or more computer-readable storage devices storing computer-executable instructions that, when executed by one or more processors, cause the one or more processors to perform operations comprising:
collecting user analytics describing modifications to one or more control settings;
determining, based on the user analytics, recency of use weight values for a plurality of control settings modified by a user;
determining, based on the user analytics, frequency of use weight values for the plurality of control settings modified by the user;
determining one or more suggested control settings and corresponding control setting weight values for each of the one or more suggested control settings;
ranking the one or more control settings and the one or more suggested control settings, the ranking being based on a combination of the recency of use weight values, the frequency of use weight values, and the control setting weight values for the one or more suggested control settings;
determining a consistent ordering of the ranked control settings;
determining whether any user preferences apply to the one or more ranked control settings; and
creating, based on the ranking, an ordering of control settings included in a customized control settings panel, the control settings included in the customized control settings panel includes at least some of the one or more control settings.

17. The one or more computer-readable storage devices as recited in claim 16, wherein the determining the one or more suggested control settings is based on a user profile and a user history.

18. The one or more computer-readable storage devices as recited in claim 16, wherein the determining the one or more suggested control settings is based on the user profiles and the user histories for a plurality of different users.

19. The one or more computer-readable storage devices as recited in claim 16, wherein the determining the one or more suggested control settings is based on a similarity of control settings not included in the ranked control settings in relation to the ranked control settings.

20. The one or more computer-readable storage devices as recited in claim 16, wherein the determining the ordering of the ranked control settings comprises:
determining, for each ranked control setting that appeared in a previous customized control settings panel, a previous position within the previous customized control settings panel; and
reordering the ranked control settings such that each ranked control setting that appeared in the previous customized control settings panel maintains a respective position within the customized control settings panel to be created.
